(19) United States
(12) Patent Application Publication
(10) Pub. No.: US 2007/0151921 A1
(43) Pub. Date: Jul. 5, 2007

(54) Self-cleaning filtration nanofiber membrane

(75) Inventors: Keiyo Nakano, Aichi (JP); Jun Kameoka, College Station, TX (US)

Correspondence Address: SCHWEGMAN, LUNDBERG, WOESSNER & KLUTH, P.A., P.O. BOX 2938, MINNEAPOLIS, MN, 55402, US

(73) Assignee: CEO ESPINEX Inc.

(21) Appl. No.: 11/324,476

(22) Filed: Jan. 3, 2006

(51) Int. Cl. B01D 71/00

(52) U.S. Cl. 210/500.21; 210/508; 428/317.9; 428/372; 977/779

(57) ABSTRACT

A self-cleaning membrane is formed of microfibers and/or nanofibers that contain functionalized nanoparticles. In one embodiment, the nanoparticles contain photo-catalytic particles, that when exposed to ultraviolet light, cause decomposition of organic molecules. The decomposed molecules may be easily flushed from the membrane. In one embodiment, the particles are titania nanoparticles, some of which are disposed on or near the outside of the fibers.

### FIELD OF THE INVENTION

The present invention relates to filtration membranes, and in particular to a filtration membrane having nanoparticles for self-cleaning and optionally sterilization of organellas.

### BACKGROUND OF THE INVENTION

Nanofibers and microfibers have a large surface to volume ratio, making them suitable for filtration applications. Membranes may be formed of nanofiber and microfibers in a variety of shapes and sizes, and may be used as filters in many different applications. In some applications, a large amount of specific organic molecules may be filtered by these membrane filters. However, the small porous size of these membranes may easily be fouled by filtered organic molecules. The delicate nature of such membranes makes standard filter cleaning methods, such as reverse flushing unworkable, as it can easily damage the membrane.

### SUMMARY OF THE INVENTION

A self-cleaning membrane is formed of microfibers and/or nanofibers that contain functionalized nanoparticles. In one embodiment, the nanoparticles contain photo-catalytic particles, that when exposed to ultraviolet light, cause decomposition of organic molecules. The decomposed molecules may be easily flushed from the membrane. In one embodiment, the particles are titania nanoparticles, some of which are disposed on or near the outside of the fibers.

### BRIEF DESCRIPTION OF THE DRAWINGS

FIG. 1A is a lateral cross section representation of a single nozzle used for fabrication of self-cleaning membranes according to an example embodiment.

FIG. 1B is s transverse cross section of a fluid with nanoparticles exiting the single nozzle of FIG. 1A.

FIG. 2A is a lateral cross section representation of a pair of coaxial nozzles used for fabrication of self-cleaning membranes according to an example embodiment.

FIG. 2B is a transverse cross section of a fluid with nanoparticles exiting the pair of coaxial nozzles of FIG. 2A.

FIG. 2C is a transverse cross section of the pair of a coaxial electrospinning source for forming nanoparticle containing fibers according to an example embodiment.

FIG. 3 is a schematic diagram of a nanoparticle coated nanofiber membrane according to an example embodiment.

FIG. 4A is a block schematic diagram of a photo-catalytic filter according to an example embodiment.

FIG. 4B is an exploded block schematic diagram of the filter of FIG. 4A.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

A self-cleaning nanofiber membrane extends usage life span of filters by decomposing adsorbed molecules. In one embodiment, the diameter of the fibers is less than 100 nm and photo-catalytic nanoparticles are embedded on their surface. They were fabricated by electrospinning technique by electrostatically extruding polymer solution blended with photo-catalytic materials such as titania nanoparticles from a variety of different sources, such as two nozzle systems, a single nozzle or a coaxial nozzle.

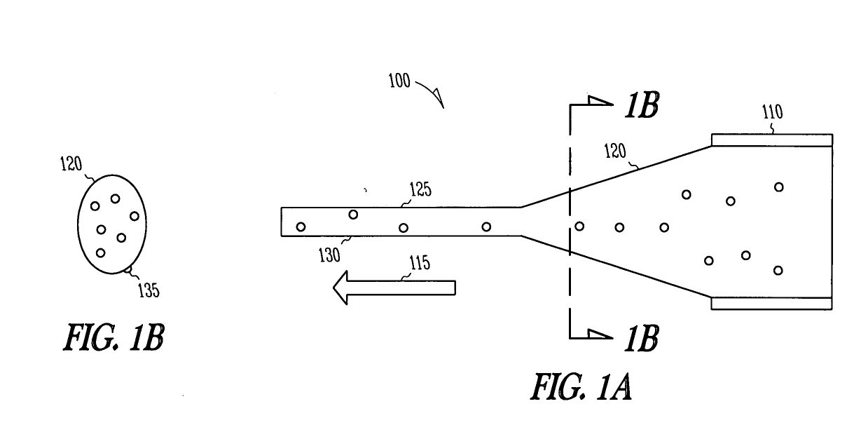

A single nozzle system for forming nanoparticle containing fibers is illustrated at 100 in FIG. 1A. A sol-gel polymer solution is blended with titania nanoparticles and electrospun from a nozzle 110. Electrospinning configurations are well known, and involve the creation of an electric field as indicated at 115, which provides a force acting on the fluid causing it to move to a desirably spaced electrode. The fluid, as seen in FIG. 1A, forms a cone 120, from which a stream 125 of fluid is ejected toward the spaced electrode. Stream 125 is fairly liquid at this point, and dries as it approaches the electrode such that it maintains a fiber shape. The spacing of the electrode can be varied, and may affect how solid the fiber is on contact with a substrate or other material placed between the electrode and cone 120.

Nanoparticles, such as photo-catalytic nanoparticles 130 are suspended within the fluid. They become part of the formed fibers. In one embodiment, the fibers are nanofibers, having diameters of between approximately 10 nm to 100 nm in one embodiment, and 50 nm to 200 nm in a further embodiment. The diameter may be controlled by varying concentration of the fluid. In one embodiment, the diameters are approximately less than 100 nm. In further embodiments, larger fibers, including microfibers may be used.

For optimal operation, at least some of the photo-catalytic nanoparticles are embedded on the surface of the nanofibers. This enables them to come in contact with organic material or organelle that may be trapped by the nanofibers when the nanofibers are formed in membrane and used as a filter. When exposed to selected frequencies of radiation, such as ultraviolet light, or other wavelengths, depending on the type of photo-catalytic particle used, the organic material decomposes, resulting in the nanofiber membranes being cleared or cleaned. Organelle may also be sterilized.

In one embodiment, titania (TiO2) particles are used. Typical particles may range in size between approximately 1 nm to 30 nm or larger. In one embodiment, the average size of the nanoparticles is approximately 6 nm. If the particles are too large, them may not embed well in the resulting fiber. In one embodiment, the concentration of particles in the fluid is between approximately 1 to 15%. It may form a colloidal solution. An acid may be included to enhance the solubility of the particles in the fluid. A high concentration of particles is desired in some embodiments to ensure a desired amount of the particles end up on the surface of the fibers.

FIG. 1B is a cross section of the fluid in cone 120. It shows the nanoparticles within the fluid and at least one nanoparticle 135 on the surface of the fluid.

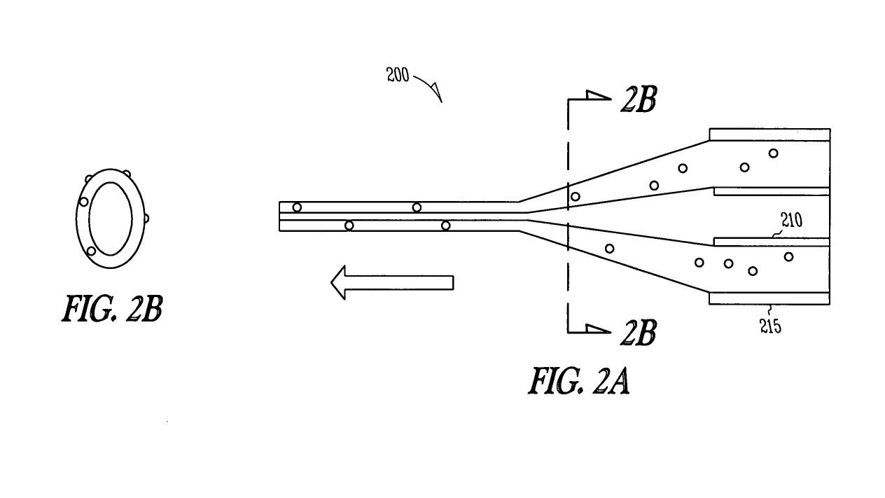

A coaxial nozzle system is shown in a longitudinal cross section in FIG. 2A generally at 200 with a transverse cross section of fluid being ejected shown in FIG. 2B, and a cross section of the nozzles shown in FIG. 2C. Coaxial nozzle system 200 has two nozzles coaxially aligned. An inner nozzle 210 provides a nanofiber substrate (silica or inorganic sol-gel material) and an outer nozzle 215 carries the photo-catalytic materials (titania nanoparticles) and more substrate. The coaxial nozzle is fundamentally utilized to localize nanoparticles 220 at, near or on an outer shell of nanofibers because of shear force of coaxial flow. So locating such particles enhances catalytic activity in response to light. In one embodiment, a substantial percentage of the nanoparticles are located at or near the surface of the nanofibers.

For both fabrication approaches, nanoparticles are tightly embedded on the surface of nanofibers. From the coaxial electrospinning source 200, a core/shell double layered polymeric jet may be extruded to localize more nanoparticles on the surface via shear force. This method may provide a better functionalized fiber because exposed photo-catalytic nanoparticles contribute to the cleaning function.

The substrates of nanofibers are normally sol-gel based inorganic materials such as silica, titania or zirconia etc. Polymeric materials may not be utilized as nanofiber material because they may also be decomposed by the photo-catalytic activity by titania nanoparticles.

The inorganic nanofiber membranes can be incorporated with glass or inorganic microfibers to enhance their mechanical strength. Photo-catalytic titania nanoparticles may also be incorporated in microfibers by melt blow fiber fabrication techniques.

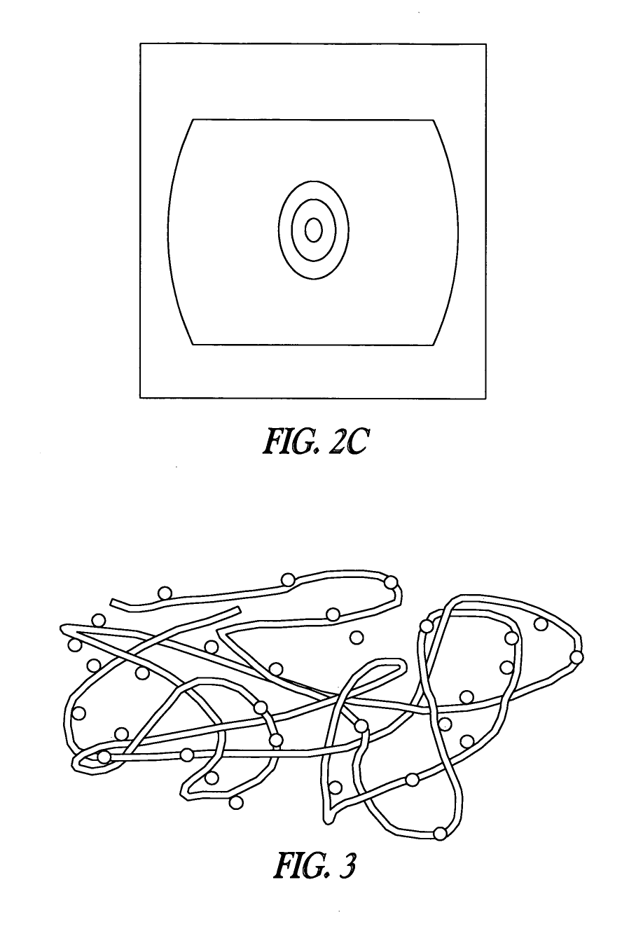

FIG. 3 is a schematic diagram of a small amount of nanofibers formed using the above systems. The nanofibers may be formed in thick mats, such as membranes. Nanoparticles immobilized at least partially at the surface of the nanofibers contribute to the cleaning. Such membranes are easily assembled for molecular filtration or immobilization applications to filter molecules. In addition, these membrane have self-cleaning functions. Organic molecules adsorbed on the nanofibers can be decomposed to prevent fouling. Such membranes may be used as molecule filters for waste, wallpapers to clean air or smell, and air refresher for automobile, etc.

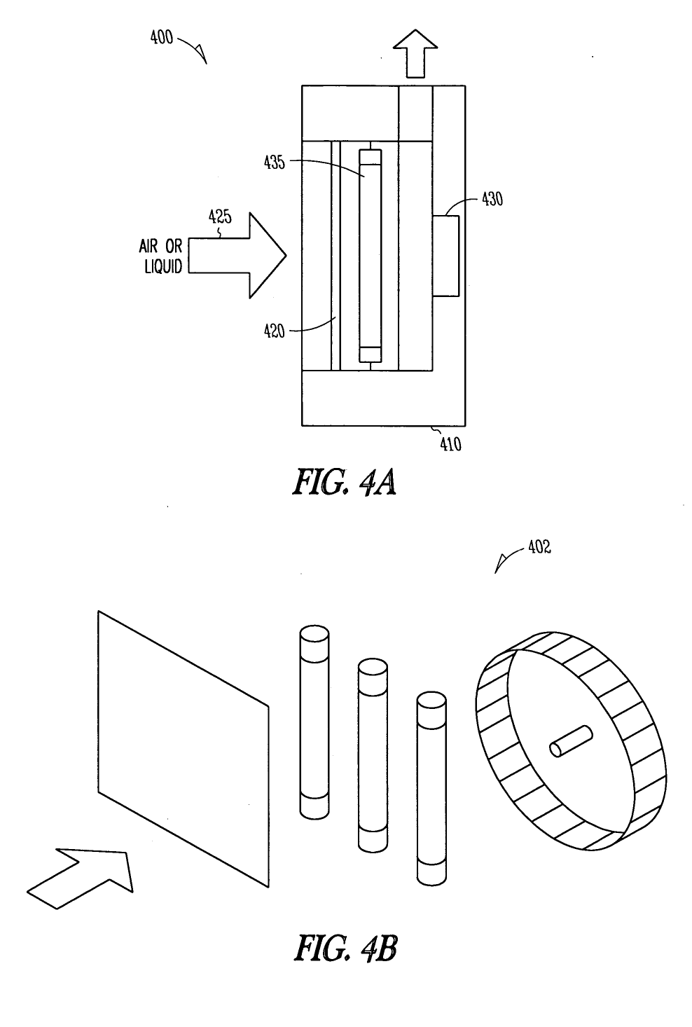

FIGS. 4A and 4B illustrate a self-cleaning nanofiber membrane cleaning device generally at 400. FIG. 4B is an exploded perspective view of the device 400. Device 400 comprises a main frame 410. A photo-catalytic nanofiber filter membrane 415 is fixed in the frame 410 near an entrance 420 of the cleaning device. Contaminated air or liquid represented by arrow 425 is transported into the device by a fan or pump 430 located at near the exit of device. Contaminants are forced through nanofiber membrane 415 and adsorbed on the nanofiber surface. A water or dust proofed UV light source 435 (LED or lamp) is located just behind of nanofiber membranes. The UV light illuminates, continuously or periodically, the membrane to decompose contaminants. The intensity of the UV light may be empirically varied to obtain desired results. The intensity may depend on how close the light source is to the nanoparticles. In one embodiment, a membrane was exposed to a 30 Watt source for between 15 and 30 minutes to obtain desired decomposition. The actual power levels and exposure times may vary dramatically depending on the application and structure of devices. The light source may be external or integrated in various embodiments.

### CONCLUSION

A self-cleaning membrane may be constructed from inorganic nanofibers or microfibers with photo catalytic nanoparticles embedded proximate the surface of the fibers. At least some of the nanoparticles are embedded proximate the surface such that at least a portion of the nanoparticles is exposed to react with organic material that may be trapped by such fibers. In one embodiment, the photo-catalytic nanoparticles are formed of titania nanoparticles having dimensions between approximately 1 nm and 15 nm. Other sizes may also be embedded in the fibers. Larger sizes may be used with larger fibers. Smaller particles may also be used. The term “fibers” is meant to cover fibers within the dimensions described herein, and smaller fibers. Further fibers may have dimensions in the nanometer range or micrometer range. In one embodiment, nanofibers create a very fine filter, that is more likely to become clogged with organic molecules.

1. A self-cleaning membrane comprising:
a fiber containing mat; and
photo-catalytic nanoparticles proximate the surface of the fibers.

2. The self-cleaning membrane of claim 1 wherein the fibers comprise nanofibers.

3. The self-cleaning membrane of claim 2 wherein the nanofibers have diameters between approximately 10 nm to 1000 nm.

4. The self-cleaning membrane of claim 1 wherein the fibers comprise microfibers.

5. The self-cleaning membrane of claim 1 wherein the photo-catalytic nanoparticles comprise titania nanoparticles.

6. The self-cleaning membrane of claim 5 wherein the titania nanoparticles have dimensions in the range of 1 nm to 30 nm.

7. The self-cleaning membrane of claim 1 wherein the photo-catalytic nanoparticles are active in response to UV light to decompose organic material.

8. A self-cleaning membrane comprising:
a nano-fiber containing mat; and
titania nanoparticles proximate the surface of the nanofibers.

9. The self-cleaning membrane of claim 8 wherein the nanofibers have diameters between approximately 10 nm to 1000 nm

10. The self-cleaning membrane of claim 8 wherein the titania nanoparticles have dimensions in the range of 1 nm to 30 nm.

11. The self-cleaning membrane of claim 8 wherein the nanoparticles are active in response to UV light to decompose organic material.

12. The self-cleaning membrane of claim 11 wherein at least some of the nanoparticles are adhered to the surface of the nanofibers.

13. The self-cleaning membrane of claim 8 wherein a substantial percentage of the nanoparticles in a nanofiber are located at or near the surface of the nanofibers.

14. A method comprising:
exposing a self-cleaning membrane comprising a fiber containing mat and photo-catalytic nanoparticles proximate to the surface of the fibers to UV light sufficient to cause a photo-catalytic reaction that decomposes organic material or sterilizes organelle.

15. The method of claim 14 wherein the fibers comprise nanofibers.

16. The method of claim 15 wherein the nanofibers have diameters between approximately 10 nm to 1000 nm.

17. The method of claim 14 wherein the photo-catalytic nanoparticles comprise titania nanoparticles.

18. The method of claim 17 wherein the titania nanoparticles have dimensions in the range of 1 nm to 30 nm.

19. The method of claim 14 wherein at least some of the nanoparticles are adhered to the surface of the fibers.

20. The method of claim 9 wherein a substantial percentage of the nanoparticles in a fiber are located at or near the surface of the fibers.
